(19) United States
(12) Patent Application Publication
(10) Pub. No.: US 2018/0354468 A1
(43) Pub. Date: Dec. 13, 2018

(54) CLEANING A VEHICLE SENSOR

(71) Applicant: Ford Global Technologies, LLC, Dearborn, MI (US)

(72) Inventors: Venkatesh Krishnan, Canton, MI (US); Andre Sykula, Sterling Heights, MI (US); Jose Garcia Crespo, Bloomfield Township, MI (US)

(73) Assignee: Ford Global Technologies, LLC, Dearborn, MI (US)

(21) Appl. No.: 15/617,914

(22) Filed: Jun. 8, 2017

(51) Int. Cl. B60S 1/56; B60R 11/02; B08B 3/02; B08B 5/02

(52) U.S. Cl. CPC B60S 1/56; B60R 11/0264; B60R 2011/004; B08B 5/02; B08B 3/02

(57) ABSTRACT

A nozzle that includes: a first member comprising an annular first flange extending radially-inwardly from a first base; and a second member having an annular second flange extending radially-outwardly from a second base, the first and second flanges forming a circumferential passage and an at least partially circumferential outlet.

### BACKGROUND

Cleaning a vehicle exterior may occur in a variety of ways. Users of the vehicle may hand-wash the vehicle at home or power-wash the vehicle at a so-called do-it-yourself station. Or the vehicle may be driven through a so-called automated car wash facility. For example, in the automated car wash, a machine having a nozzle is located proximate to the vehicle; thereafter, a soap and water mixture may be applied to the vehicle exterior, and a series of brushes on the machine may remove dirt and debris. The machine further may rinse and blow-dry the vehicle.

### BRIEF DESCRIPTION OF THE DRAWINGS

FIG. 1 is a perspective view of autonomous vehicle having a sensor cleaning system.

FIG. 2 is a schematic view of a pumping system of the vehicle shown in FIG. 1.

FIG. 3 is an exploded, perspective view of a sensor, a nozzle, and a portion of a supply passage providing fluid to the nozzle for cleaning the sensor.

FIG. 4 is a sectional top view of the nozzle illustrating a fluid-flow pattern therein.

FIG. 5 is a perspective bottom view of a portion of the nozzle.

FIG. 6 is a sectional view of the nozzle carried by the sensor

FIG. 7 is a cut-away view of the nozzle carried by the sensor further illustrating the exemplary fluid-flow pattern shown in FIG. 4.

### DETAILED DESCRIPTION

According to an illustrative example, a cleaning system for a vehicle is described. The system may include a nozzle that includes: a first member having a first base and an annular first flange extending therefrom; a second member, coupled to the first member, having a second base and an annular second flange extending therefrom, the first and second flanges forming a passage; an inlet; and an outlet formed by the first and second flanges, wherein the inlet, the passage, and the outlet are in fluid communication with one another.

According to the at least one example set forth above, the system further may include a plurality of sensors and a plurality of nozzles, wherein each of the plurality of sensors is coupled one of the plurality of nozzles.

According to the at least one example set forth above, at least one of the plurality of sensors is a light detection and ranging (LIDAR) device that provides imaging data to an autonomous driving system in a vehicle.

According to the at least one example set forth above, the system further may include at least one supply passage and a pumping system that includes at least one pump, wherein the pumping system is in fluid communication with the nozzle via the at least one supply passage.

According to the at least one example set forth above, the system further may include a computer having a processor and memory having instructions executable by the processor that include selectively controlling the pumping system to deliver fluid to the nozzle.

According to the at least one example set forth above, the at least one pump comprises a first fluid pump within a reservoir adapted to deliver a liquid-fluid to the nozzle, wherein the at least one pump further comprises a second fluid pump adapted to deliver a gaseous-fluid to the nozzle.

According to another example, a nozzle is disclosed that includes: a first member comprising an annular first flange extending radially-inwardly from a first base; and a second member having an annular second flange extending radially-outwardly from a second base, the first and second flanges forming a circumferential passage and an at least partially circumferential outlet.

According to the at least one example set forth above, the first base is diametrically larger than the second base.

According to the at least one example set forth above, at least a portion of the first flange is parallel to at least a portion of the second flange.

According to the at least one example set forth above, a width of the outlet is uniform.

According to the at least one example set forth above, the first or second member includes a circumferentially-extending wall protruding from the respective first or second base, wherein the wall is located inboard of the second flange, wherein an edge of the wall abuts the respective second or first base.

According to the at least one example set forth above, a peripheral region of the first base, the first flange, the wall, and the second flange form the passage.

According to the at least one example set forth above, the nozzle further includes a fluid inlet formed in the first member, the second member, or both.

According to the at least one example set forth above, the inlet is adapted to direct fluid tangentially into the passage to cause a circumferential fluid flow therein.

According to the at least one example set forth above, the nozzle further includes a fastener that couples the first member to the second member and that couples the first and second members to a sensor.

According to the at least one example set forth above, a system is disclosed that includes the nozzle coupled to a sensor of a vehicle; a first supply passage coupled to an inlet of the nozzle; and a first pump adapted to provide a first fluid to the nozzle, via the first supply passage, for application to the sensor.

According to the at least one example set forth above, the system further includes a second supply passage coupled to a second pump adapted to provide a second fluid to the nozzle, wherein the first fluid is different from the second fluid.

According to the at least one example set forth above, the second supply passage merges with the first supply passage before the first supply passage couples to the inlet.

According to the at least one example set forth above, the system further includes at least one bracket that couples the sensor to the vehicle.

According to the at least one example set forth above, the system further includes a second sensor, a second nozzle, a second supply passage, and the vehicle, wherein the first and second sensors are positioned on respective A-pillars of the vehicle, wherein respective first and second supply passages are located along respective sides of the first and second sensors so that respective dead zones of the first and second sensors are oriented vehicle-inwardly.

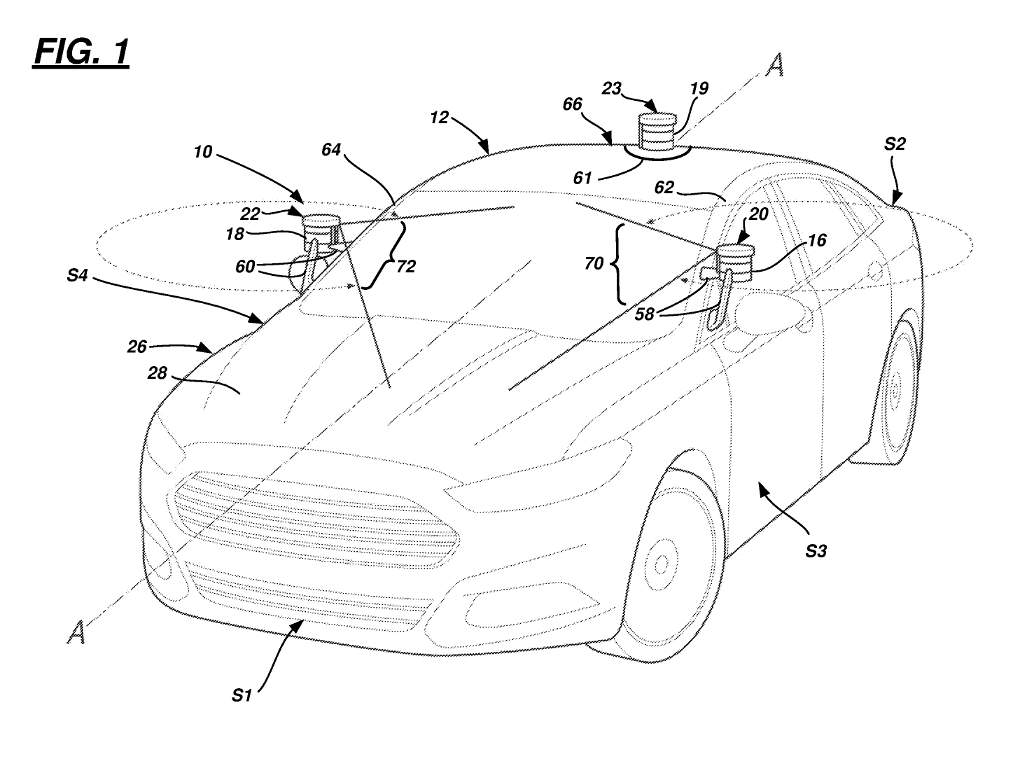

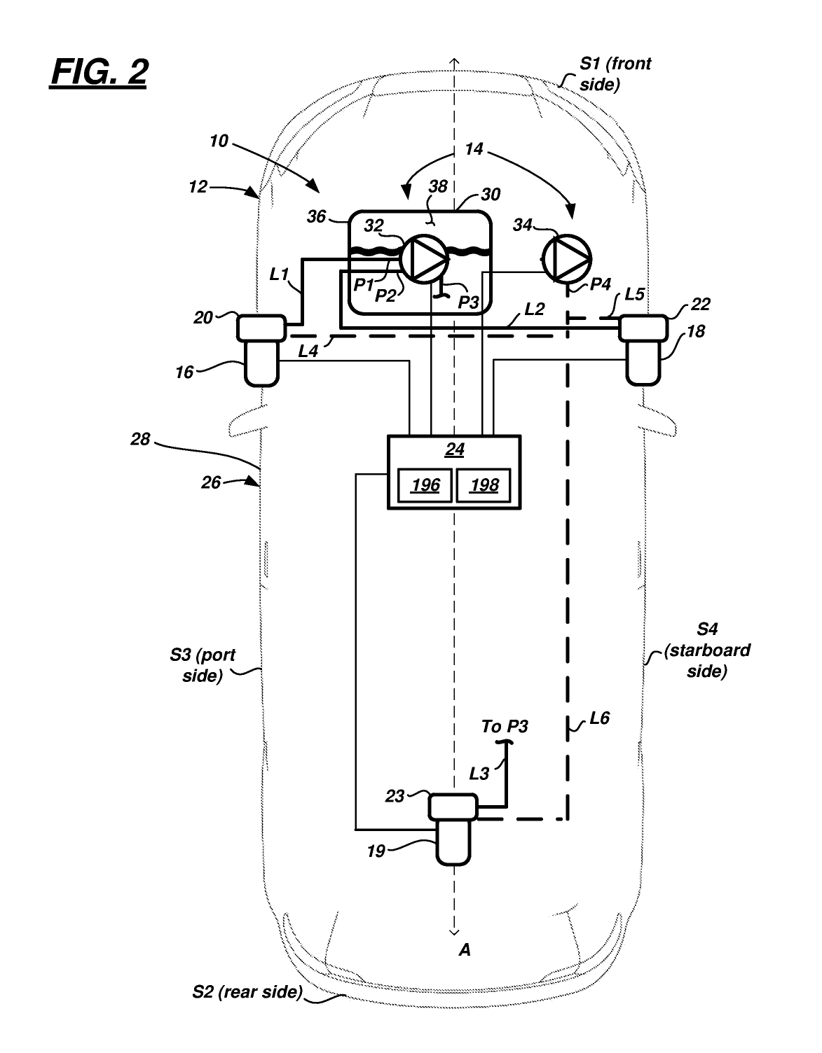

Now turning to the figures, wherein like numerals indicate like parts throughout the several views, there is shown a cleaning system 10 for a vehicle 12 (e.g., see FIGS. 1-2). As an example, the cleaning system 10 may include a pumping system 14, one or more vehicle sensors 16, 18, 19, one or more fluid-dispensing nozzles 20, 22, 23 respectively coupled to sensors 16, 18, 19, one or more supply passages L1, L2, L3, L4, L5, L6 permitting fluid communication between the pumping system 14 and the nozzles 20-23, and an onboard computer 24 programmed to control the pumping system 14. As will be described in greater detail below, the pumping system 14 may provide air or liquid to the nozzles 20-23 so that the nozzles may dispense the air and/or liquid onto the surfaces of the corresponding sensors 16-19 thereby removing debris therefrom. In at least one example, as described below, the sensors 16-19 are light detection and ranging (LIDAR) devices which provide autonomous driving data to computer 24. Typically, sensors 16-19 each have a curved window facilitating a relatively large field of view (e.g., between 180° and 360°), and as will be described below, the nozzles 20-23 may be adapted to clean these sensor windows.

The vehicle 12 is shown as a passenger car; however, vehicle 12 could also be a truck, sports utility vehicle (SUV), recreational vehicle, bus, train, marine vessel, aircraft, or the like that includes the sensor cleaning system 10. According to at least one example, the vehicle 12 may be operated in any one of a number of autonomous modes using computer 24, (as described more below). For example, vehicle 12 may operate in a fully autonomous mode (e.g., a level 5), as defined by the Society of Automotive Engineers (SAE) (which has defined operation at levels 0-5), as explained more below. In other examples, vehicle may operate at levels 0-2, wherein a human driver monitors or controls the majority of the driving tasks, often with no help from the vehicle 12. For instance, at level 0 (“no automation”), a human driver is responsible for all vehicle operations. At level 1 (“driver assistance”), the vehicle 12 sometimes assists with steering, acceleration, or braking, but the driver is still responsible for the vast majority of the vehicle control. At level 2 (“partial automation”), the vehicle 12 can control steering, acceleration, and braking under certain circumstances without human interaction. In other examples, vehicle may operate at levels 3-4, wherein the vehicle 12 assumes more driving-related tasks. For instance, at level 3 (“conditional automation”), the vehicle 12 can handle steering, acceleration, and braking under certain circumstances, as well as monitoring of the driving environment. Level 3 may require the driver to intervene occasionally, however. At level 4 (“high automation”), the vehicle 12 can handle the same tasks as at level 3 but without relying on the driver to intervene in certain driving modes. And in at least one example, vehicle 12 operates at level 5 (“full automation”), wherein the vehicle 12 can handle all tasks without any driver intervention.

Vehicle 12 may comprise a body 26 that may be of a unibody construction in which at least some of the body 60 is exposed presenting a so-called class-A surface 28, i.e., a surface 28 specifically manufactured to have a high-quality, finished aesthetic appearance free of blemishes. Alternatively, body 26 may be of a body-on-frame construction, or of any other suitable construction. Regardless, body 26 may be formed of any suitable material, for example, steel, aluminum, etc.

Pumping system 14 may comprise a reservoir 30, at least one first fluid pump 32 carried within the reservoir 30, and/or at least one second fluid pump 34 which may be located outside the reservoir 30. The reservoir 30 may include one or more walls 36 which define an enclosed cavity 38 adapted to retain a first fluid. In at least one example, the first fluid is a liquid cleaning solution such as water, windshield washer fluid, or the like; however, this is not required (e.g., in other examples, the first fluid may be any suitable gas or other fluid).

The first pump 32 may be located at least partially within the cavity 38 (e.g., at least partially submerged within the first fluid)—e.g., having an intake (not shown) which receives and pressurizes the first fluid and delivers it to the nozzles 20-23 via one or more of passages L1-L3, as described more below. The first pump 32 may be any suitable electronically-actuatable pump. Non-limiting examples include one or more positive displacement pumps (e.g., gear pumps, impeller pumps, plunger pumps, etc.), one or more velocity pumps (e.g., including jet pumps, jet valves, etc.), a combination thereof, or the like.

The first pump 32 further may include one or more electronically-actuatable ports P1, P2, P3. In one example, when selectively actuated by computer 24, port P1 provides the first fluid to nozzle 20 via passage L1, when selectively actuated by computer 24, port P2 provides the first fluid to nozzle 22 via passage L2, and when selectively actuated by computer 24, port P3 provides the first fluid to nozzle 23 via passage L3. This arrangement is merely an example. For instance, the pump 32 could be controlled to provide concurrently first fluid to any combination of nozzles 20-23 via a single port (e.g. such as port P1). Or in another example, the ports P1, P2, P3 could be embodied as computer-controlled valves which are located at any suitable position along respective passages L1, L2, L3—e.g., the ports P1, P2, P3 could be electronically-actuatable flow-control valves or the like.

According to at least one example, the reservoir 30 and first pump 32 may be shared with other vehicle systems. For example, in one instance, the reservoir 30 and first pump 32 could be used to deliver the first fluid to the vehicle front windshield, vehicle rear windshield, vehicle headlamps, a combination thereof, or the like.

As discussed above, the second pump 34 may not require the use of a reservoir. Second pump 34 may pressurize a second fluid (e.g., such as air or other gas) and selectively provide it to the nozzles 20-23 (e.g., via passages L4-L6, respectively). In at least one example, second pump 34 also may include at least one electronically-actuatable pump such as a positive displacement pump or the like (including pump examples cited above). It should be appreciated that only two pumps 32, 34 are shown; however, any suitable quantity of pumps may be used to deliver a first or second fluid to the nozzles 20-23 so that debris may be removed from the vehicle sensors 16-19, as will be explained in greater detail below. For example, reservoir 30 may carry multiple pumps (or system 14 may comprise multiple reservoirs each having one or more pumps). Further, while the pumping system 14 is shown near a front side S1 of vehicle 12, this is not required (e.g., elements of pumping system 14 may be located at or near front side S1, rear side S2, port side S3, or starboard side S4).

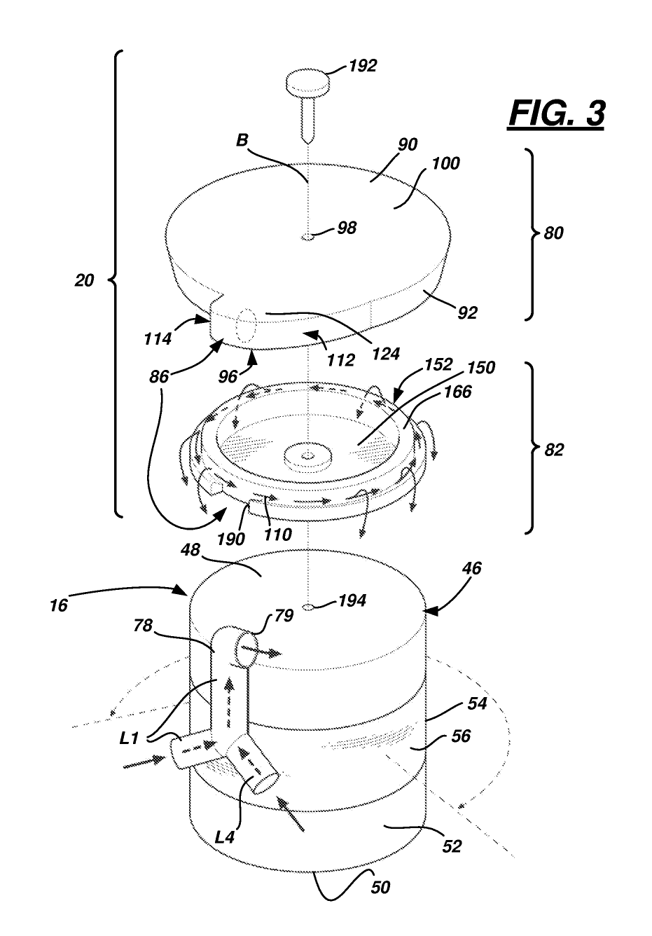

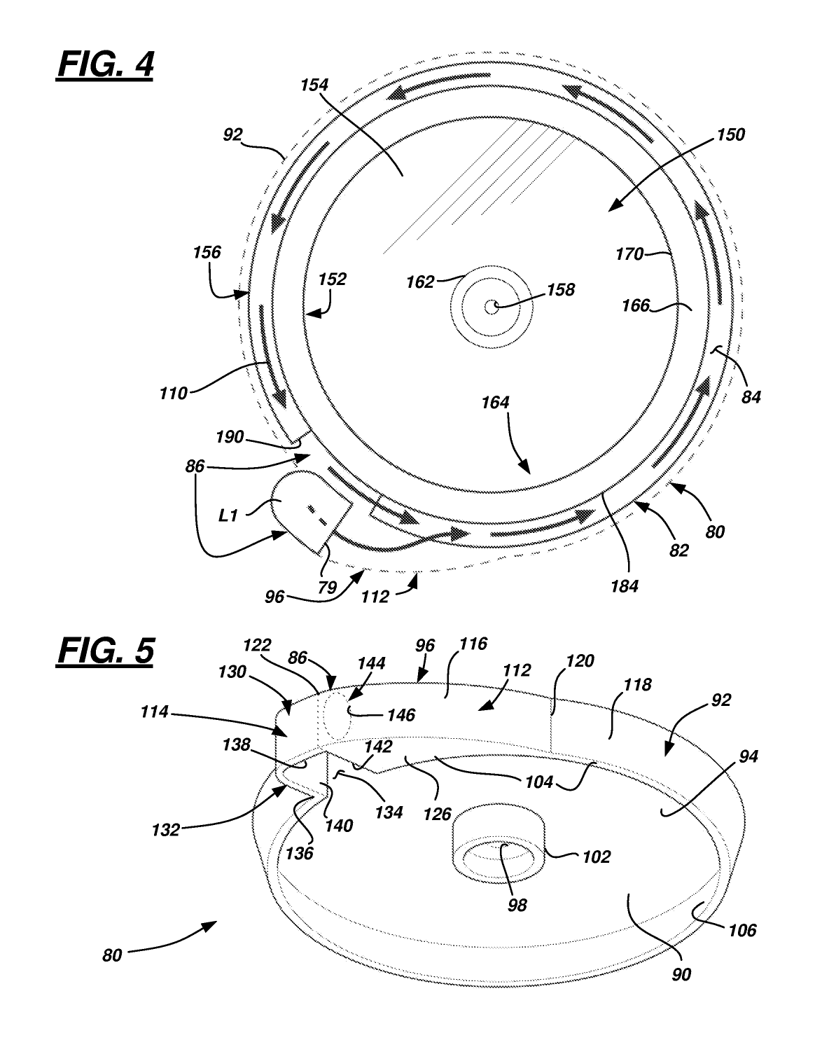

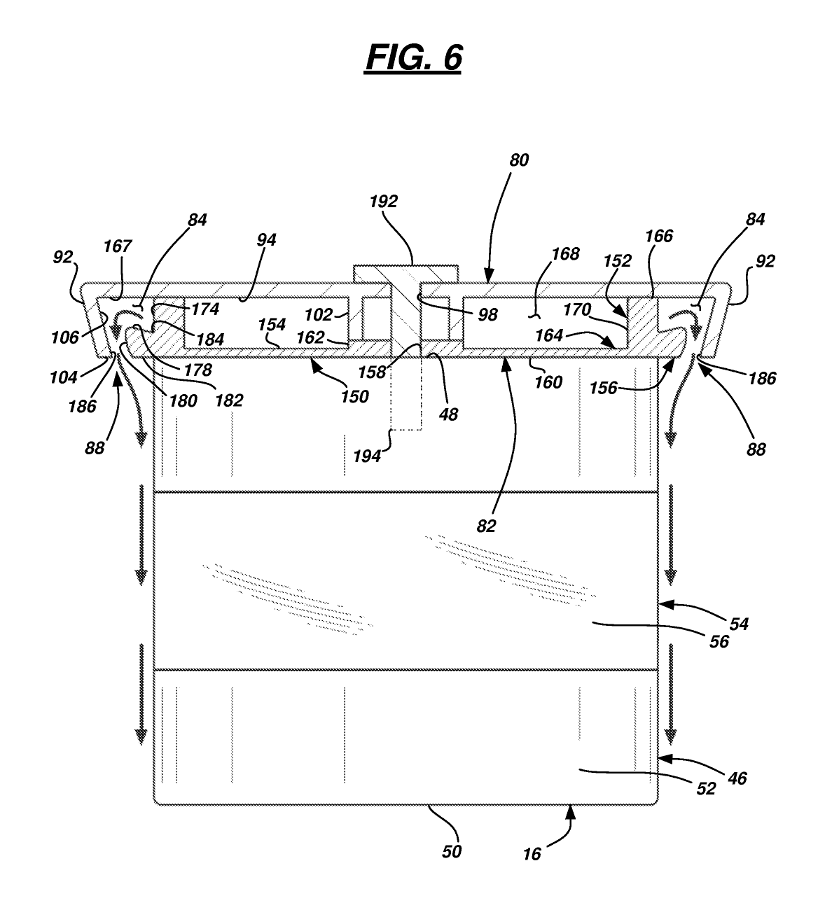

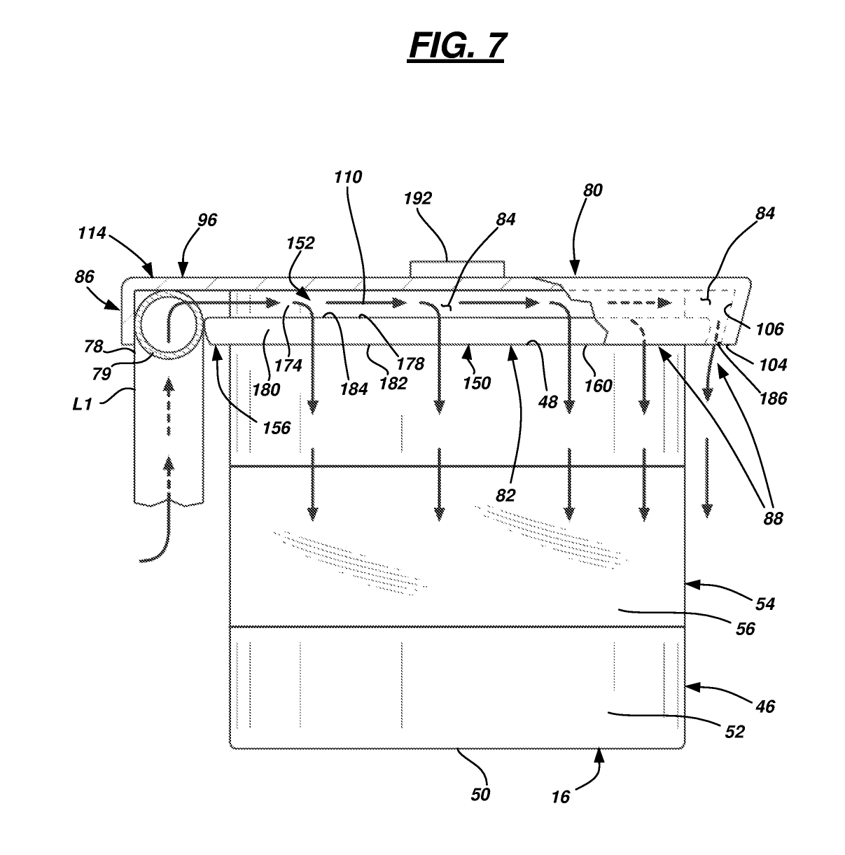

Turning now more particularly to FIGS. 3-7, sensor 16 and nozzle 20 are shown. In at least one example, sensor 16 is identical to sensors 18-19, and nozzle 20 is identical to nozzles 22-23; therefore, only one of each will be described below. Sensor 16 may comprise a housing 46 having a top 48, a bottom 50, and the at least one circumferentially-extending side 52 extending between the top 48 and bottom 50—the top 48, bottom 50, and side(s) 52 collectively defining an interior volume (not shown). The illustrated housing 46 is a right cylinder; however, this is not required. For example, housing 46—and more particularly side 52—may have different shapes (e.g., non-limiting examples include an at least partially circular cylinder, an at least partially elliptic cylinder, an at least partially ovoid shape, an at least partially parabolic cylinder, an at least partially hyperbolic cylinder, an at least partially angular or multi-faceted shape, or the like). In addition, the shape of the housing 46 may be oblique, rather than right.

Housing 46 may carry an optically-transmissive window 54 (e.g., comprised of glass, acrylic, etc.) and a panoramic sensing element (not shown; e.g., a so-called detector, imaging engine, imaging core, or the like). An exterior surface 56 of window 54 at least partially circumferentially extends around side(s) 52. And in at least one example, a contour of the window 54 follows the shape of the housing 46 (e.g., the shape of window 54 also may be cylindrical). In other examples, window 54 may be otherwise curved or even at least partially angular (e.g., elliptical, parabolic, faceted, etc., as described above).

While not shown, it should be appreciated that the sensing element may be positioned within the housing 46 and relative to an inner surface (not shown) of window 54 so that the sensing element may receive and/or focus light and/or other radiation onto one or more detecting surfaces thereof. In this manner, the sensing element may provide imaging data from the vehicle's surroundings to one or more computing devices (e.g., such as computer 24)—thereby enabling computer 24 to control vehicle 12 in a fully autonomous or other autonomous mode. In some examples, the sensing element mechanically rotates within the housing 46, relative to the window 54. In other examples, the sensing element is fixed within the housing 46—e.g., the detecting surface(s) of the sensing element being positioned and oriented to suitably receive light and/or radiation through window 54.

The housing 46 may have any suitable size. According to one example, the housing 46 has a circular diameter less than five (5) inches and a height less than four (4) inches. Further, in one example, window 54 is circular having a diameter less than five (5) inches and a height that is less than two (2) inches—the window 54 circumferentially extending around the entirety of side 52—enabling the sensor 16 to have up to a 360° field of view (FOV).

According to one example, sensor 16 is a light detection and ranging (LIDAR) device. One non-limiting commercial implementation is the VLP-16 by Velodyne LiDAR, Inc. However, this is merely an example and is not required. Sensor 16 also could be a charge-coupled device (CCD) camera, a complementary metal-oxide semiconductor (CMOS) camera, a near infrared (NIR) device (e.g., operating in 0.74-1 micrometer (μm) range), a thermal imaging or forward-looking infrared (FLIR) device (e.g., operating in the short (1-3 μm), medium (3-5 μm), or long (8-14 μm) ranges), or the like. Also, in some examples, sensor 16 could be a LIDAR device while sensor 18 or 19 could be a different type of sensor (or vice-versa); however, in at least one example, sensors 16-19 are all LIDAR devices. In yet other examples, vehicle 12 may comprise only one or two sensors—or in other examples, it may comprise more than the three illustrated sensors 16-19.

Cleaning system 10 also may comprise one or more brackets 58, 60, 61 (e.g., such as those shown in FIG. 1) which are adapted to carry sensors 16, 18, 19, respectively, on vehicle 12. In at least one example, sensor 16 is mounted to an A-pillar 62 on port side S3 via bracket(s) 58, sensor 18 is mounted to an A-pillar 64 on starboard side S4 via bracket(s) 60, and sensor 19 is mounted to a rear region 66 (e.g., such as a vehicle roof, lift-gate door, trunk door or hatch, etc.) via bracket(s) 61. Thus, according to one arrangement, sensor 16 can be oriented to receive imaging data of a port-side field of view (FOV) that spans radially toward a vehicle-forward direction (e.g., extending to and/or through a longitudinal vehicle centerline axis A), sensor 18 can be oriented to receive imaging data of a starboard-side FOV that spans radially toward the vehicle-forward direction (e.g., extending to and/or through axis A), and third sensor 19 can be oriented to receive imaging data of a vehicle rear-side FOV that includes at least a portion of the port-side and starboard-side FOVs. These are merely examples; sensors 16-19 also could be mounted to other components of body 26 and/or in other locations on vehicle 12.

Sensors 16, 18, 19 each may have a so-called dead zone (note: illustrated dead zones 70, 72 correspond to sensors 16, 18, respectively; no dead zone is illustrated for sensor 19; however, one may or may not exist). As used herein, a dead zone is a region wherein the respective sensor (e.g., sensing element) either does not receive imaging data due to its optical configuration (e.g., aperture size and shape, focal parameters, or the like) or it does not receive imaging data due to a shroud, physical obstruction, or other structure (such as one or more fixed vehicle components). A measure of the respective dead zones 70, 72 may be determined by the equation dead zone horizontal size=360°−HFOV_{EFF}, wherein HFOV_{EFF} is the effective horizontal field of view of the respective sensor (e.g., based on the sensor configuration, shroud, obstructions, structures, etc. within the horizontal FOV). As will be explained more below, at least a portion of the cleaning system 10 (e.g., a portion of one or more of supply passages L1-L6) may obstruct the respective sensors' HFOV_{EFF} as at least a portion of some of the respective supply passages may be located along the side(s) 52 of the respective sensors so that the respective dead zones are oriented vehicle-inwardly. In at least some examples, each the dead zone 70, 72 is between 5° and 90° (e.g., approximately 45°). However, it should be appreciated that a dead zone is not required in all examples.

As shown in FIG. 1, sensors 16, 18 may be oriented on the respective A-pillars 62, 64 so that the dead zones 70, 72 do not negatively affect operating vehicle 12 in a fully autonomous mode (e.g., the dead zones may be oriented toward vehicle centerline axis A). Positioning and orientation of sensors 16-19 may be optimized for capturing imaging data around vehicle 12 and operating in a fully autonomous mode; however, these locations and/or orientations may make cleaning the sensors 16-19 difficult. As described more below, nozzles 20-23 may clean debris from the surface of the respective windows 54—e.g., by first applying compressed air and then, if necessary, applying a liquid cleaning solution (e.g., as selectively controlled by computer 24). As used herein, debris should be broadly construed to include dirt, dust, sand, mud, pollen, insect or animal body parts or feces, pieces of rubbish or waste, ice, snow, food, other like contaminants, etc.

The first or second fluid (e.g., liquid or air) may be delivered to the nozzles 20-23 via passages L1-L6, as described above. These passages may include any suitable tube, pipes, conduits, fittings, joints, couplers, valves, etc. adapted to deliver pressurized contents. They may be comprised of metal, plastic, and/or any suitable composite. As shown in FIG. 3, passage L4 may adjoin passage L1, and passage L1 may include an elbow region 78 that extends to nozzle 20. Thus, a first fluid may be delivered to nozzle 20 via passage L1, and a second fluid may be delivered to nozzle 20 via passages L4 and via a portion of L1 (these passages being in fluid communication with one another). The elbow region 78 may comprise any suitable bend or turn which enables an end 79 of passage L1 to deliver fluid into nozzle 20, as described below. In at least one example, passages L1 and L4 form (or merge at) a Y-intersection; however, this is not required. Passages L2, L5 and passages L3, L6—which correspond to nozzles 22, 23, respectively—may be similarly arranged; therefore, this will not be described in greater detail.

Each of nozzles 20-23 may be identical; therefore, only one nozzle (20) will be described below (see FIGS. 3-7) with respect to its corresponding sensor (16). Nozzle 20 comprises a two-piece (or two-part) design; e.g., nozzle 20 comprises a first or upper member 80 coupled to a second or lower member 82 to form a passage 84 which receives the first or second fluid from the end 79 of passage L1 into a fluid inlet 86 and delivers the fluid to the sensor window 54 via an at least partially circumferential outlet 88. Upper member 80 comprises a base 90, a circumferential flange 92 extending from one side 94 (e.g., lower side) of the base 90 (e.g., shown downwardly), and a port element 96 located on the flange 92 which forms at least part of the inlet 86.

The base 90 may be flat, and its shape and size may correspond to the shape of the sensor housing 46. For example, where the top 48 of sensor 16 is circular, the base 90 also may be circular; however, this is merely an example (and is not required in all examples). A diameter of the base 90 may be larger than the top 48 of sensor 16 so that fluid dispensed from the outlet 88 may travel downwardly along the side(s) 52 thereof. The base 90 also may have a through-hole 98 extending from an upper side 100 of the base 90 to the lower side 94 thereof (e.g., and in one example, the hole 98 may be centered, located along a longitudinal axis B of nozzle 20). In one example, a boss 102 (along axis B) comprising a circumferentially-extending wall may protrude from the lower side 94 for positioning the upper member 80 relative to the lower member 82; however, the boss is not required. The hole 98 may be located within the boss 102, as illustrated.

Flange 92 may be adapted to form a portion of the passage 84—e.g., when coupled to lower member 82, as described below. The flange 92 may extend both axially (from the lower side 94) and radially inwardly with respect to axis B terminating at an edge 104. An angle formed between an inner surface 106 of the flange 92 and base 90 may be suitable to direct fluid flow toward surface 56 of window 54 (e.g., non-limiting examples include an angle measuring45°-90°). According to one example, the larger the diameter of the base 90, the smaller the angle may be—e.g., such that when the diameter of the base 90 is marginally larger than the diameter of the sensor top 48 (e.g., 5-10% larger), the angle may be 80°-90°.

Port element 96 may be adapted to direct fluid into the passage 84 formed by the upper and lower members 80, 82 thereby promoting a circumferential fluid-flow direction 110 within the respective nozzle 20 (e.g., here a counterclockwise fluid-flow direction is shown (from the top views); however, the port element 96 could be arranged to promote a clockwise fluid-flow direction instead). In at least the illustrated example, port element 96 protrudes radially outwardly of flange 92 and may comprise a ramp portion 112 and a receptacle portion 114. The ramp portion 112 includes an outer wall 116 that may extend radially-outwardly from an outer surface 118 of flange 92 at a first region 120. The ramp portion 112 may extend circumferentially and radially-outwardly from the first region 120 to a second region 122 that is adjacent the receptacle portion 114 (e.g., having any suitable slope or curvature) (e.g., the first region 120 being arcuately spaced from the second region 122). In the illustration, the ramp portion 112 extends gradually radially outwardly in a clockwise direction (e.g., from a top view); however, this is merely one example. Ramp portion 112 further may comprise an upper wall 124 and lower wall 126. The upper wall 124 may be comprise a radially-outwardly extension of base 90—e.g., extending to the outer wall 116. The lower wall 126 may extend from the flange edge 104 to the outer wall 116. Thus, outer, upper, and lower walls 116, 124, 126 may direct fluid received from the end 79 of passage L1 into the passage 84.

Receptacle portion 114 may include a first wall 130 and a second wall 132 arranged to define a cavity 134 sized to receive the end 79 of the passage L1. More particularly, first wall 130 may extend circumferentially from the outer wall 116 in the clockwise direction to the second wall 132 (from the top view)—and the second wall 132 may extend radially inwardly adjoining the outer surface 118 of flange 92 at a third region 136 (e.g., wherein the third region 136 is arcuately spaced from both the first and second regions 120, 122). Accordingly, the cavity 134 may be defined by an inner surface 138 of the first wall 130, an inner surface 140 of the second wall 132, and a third wall 142 which extends inwardly from the first wall 130 to the flange edge 104. The third wall 142 may include a coupler 144 adapted to receive the end 79 of passage L1. According to one example, the coupler 144 includes an opening 146 sized to receive end 79. The third wall 142 is optional; e.g., the passage end 79 may be press-fit within the cavity 134 so as to direct fluid directly into the ramp portion 112, or the coupler 144 could be attached to any suitable part or surface of the upper member 80, or the like.

Turning now to the lower member 82, the lower member 82 may include a base 150, a circumferential wall 152 extending from an upper side 154 of the base 150, and a flange 156 extending radially outwardly of the wall 152 (e.g., also on the upper side 154). The base 150 may be flat, and its shape and size also may correspond to the shape of the sensor housing 46. For example, where the window 54 of sensor 16 is cylindrical, the base 150 may be circular; however, this is merely an example (and is not required in all examples). In addition, a lower side 160 of base 150 may be located adjacent the top 48 of sensor 16. The lower side 160 may be flat or have any other suitable shape—e.g., and it may or may not follow the contour of top 48.

A diameter of the base 150 may be larger than the diameter of sensor 16 but smaller than that of the upper member 80—e.g., in order to direct fluid downwardly along the side(s) 52 thereof (as will be described more below). The base 150 may have a through-hole 158 extending from the upper side 154 of the base 150 to the lower side 160 thereof (e.g., and the hole may be centered along axis B).

In one example, a boss 162 (along axis B) comprising a circumferentially-extending wall may protrude from the upper side 154 for positioning the lower member 82 relative to the upper member 80 and the sensor 16; however, the boss 162 is not required. The hole 158 may be located within the boss 162. When assembled, bosses 102, 162 may abut one another as shown and act as spacers. According to at least one example, the boss 162 may serve as an alignment guide for boss 102 during assembly—e.g., the diameter of boss 102 may be larger than that of boss 162 enabling boss 102 to slide over boss 162 (or the diameters could differ enabling boss 162 to slide over boss 102); other examples of bosses 102, 162 are also possible.

The circumferential wall 152 may be located in an outboard region 164 of the base 150 and may extend axially therefrom terminating at an edge 166. When upper and lower members 80, 82 are assembled, edge 166 may abut the lower side 94 of upper member 80. As shown best in FIG. 6, the location of wall 152 relative to side 94 may define a periphery region 167 on the lower side 94 of upper member 80 (e.g., outboard of wall 152), and the region 167 and inner surface 106 of the flange 92 may form a portion of passage 84.

On lower member 82, an interior region 168 may be located inwardly of wall 152—e.g., a volume of the interior region 168 defined by the lower side 94 of upper member 80, an inner surface 170 of the wall 152, the upper side 154 of lower member 82, and the bosses 102 and/or 162. The edge 166 may be press-fit against the lower side 94 of upper member 80 so that this interior region 168 is sealed off from fluid flow within passage 84 (thereby promoting greater fluid pressure at the outlet 88). In one example, the interior region 168 is hollow for weight-saving purposes; however, this is not required.

The flange 156 may be coupled to and extend radially-outwardly from an outer surface 174 of the circumferential wall 152. Flange 156 may comprise an upper surface 178 that extends outwardly from surface 174, an edge surface 180, and a lower surface 182—edge surface 180 extending between the upper and lower surfaces 178, 182. In at least one example, the angle formed between the outer and upper surfaces 174, 178 may be less than 90° thereby creating a channel 184 of passage 84 which promotes circumferential fluid flow and circulation.

The edge surface 180 may define a diameter of the lower member 82. In at least one example, the diameter of edge surface 180 is less than a diameter of inner surface 106 (e.g., measured nearer edge 104). And according to one example, at least a portion of edge surface 180 and at least a portion of inner surface 106 may be parallel and oriented to direct fluid flow axially and radially inwardly.

Collectively, inner surface 106 of flange 92 (upper member 80) and edge surface 180 of flange 156 (lower member 82) define an opening 186 of outlet 88. In at least one example, a width of the opening 186 may be uniform thereby promoting an even delivery of fluid pressure from the outlet 88. According to one example, the circumferential outlet 88 extends entirely around the lower member 80. And according to another example, the circumferential outlet 88 extends partially therearound—e.g., at least 360° less the span of the dead zone 70 of the corresponding sensor 16.

When mounted to sensor 16, lower surface 182 may extend radially outwardly farther than the side(s) 52 of the housing 46. This is not required however (e.g., the edge surface 180 instead could be flush with the side(s) 52).

According to at least one example, the inlet 86 of nozzle 20 further includes a notch 190 within flange 156 (of lower member 82), as well as the port element 96 (of upper member 80). For example, the notch 190 may include a circumferential region wherein the flange 156 is absent and the circumferential wall 152 extends from the edge 166 to the lower side 160 of lower member 82. When assembled, the notch 190 may be aligned with the cavity 134 of the receptacle portion 114 (of upper member 80) so that flange 156 does not interfere with the end 79 of passage L1 when the end 79 is inserted therein. Notch 190 is optional and is not required in all examples. Thus, inlet 86 may comprise the port element 96, the notch 190, or a combination thereof. Thus, the inlet 86 includes any suitable means for coupling the respective passage (e.g., passage L1) to the nozzle 20—e.g., including any suitable fluid connectors, any suitable fasteners (e.g., such as ring clamps, clips, etc.), and/or the like.

According to at least one example, the shape of the nozzle 20 is circular—corresponding to the cylindrical shape of sensor 16. Thus, in this example, the base 90 (of upper member 80) is circular and the flange 92 and edge 104 are annular. Similarly, with respect to the corresponding lower member 82, the base 150 is circular and the wall 152 and flange 156 are annular. Accordingly, in at least one example, the passage 84 is annular—e.g., as the collective features that form the passage 84 are annular (e.g., features such as the inner surface 106, the periphery region 167, the outer surface 174, the channel 184, the edge surface 180, etc.). Further, as best shown in FIG. 6, in this example, a cross-section of the passage 84 may be L-shaped. Of course, this is merely one example.

An elliptically-shaped (and especially an annularly-shaped) passage 84 may promote an entrainment effect which is useful in removing debris from window 54. The entrainment effect is a phenomenon that pertains to moving an unpressurized fluid based on the movement of a pressurized fluid resulting in an overall increase in fluid movement. More specifically, the unpressurized fluid near a moving (pressurized) fluid begins to move in the direction of the moving fluid—moving this unpressurized fluid can be dependent upon the shape of the outlet through which the pressurized fluid is directed. In the present case, the entrainment effect can cause an increase in fluid velocity as a result of the pressurized fluid moving through circumferential outlet 88. More particularly, unpressurized fluid that is located around the inner surface 106, around the edge surface 180, around the lower surface 182, etc. begins to move with the pressurized fluid delivered (from the pumping system 14 and) through outlet 88 thereby increasing the overall flow rate on the window 54 and improving debris removal. Thus, according to at least one example, a so-called air blade may comprise both compressed air delivered via passage L1 and unpressurized air located around the outlet 88.

The nozzle 20 further may comprise a fastener 192 which retains the upper and lower members 80, 82 to the sensor 16. For example, the fastener 192 may be located through both through-holes 98, 158 and into a blind hole 194 or other suitable attachment feature in the top 48 of housing 46. The term fastener should be construed broadly to include any device that suitably retains the nozzle 20 to sensor 16. In at least one example, the term fastener should be construed broadly to include any device that suitably retains the nozzle 20 to the top 48 of sensor 16. In some examples, the fastener 192 also may retain the orientation of the upper member 80 with respect to the orientation to the lower member 82; however, this is not required. Non-limiting examples of fastener 192 include one or more screws, bolts, nails, pins, clips, clamps, locks, a combination thereof, etc.

Coupling or mounting the nozzle 20 to the top 48 of sensor 16 may prevent the outlet 88 from becoming clogged (or at least partially clogged). For example, if the outlet 88 were directed upwardly, debris may fall into the outlet 88—e.g., or even be removed from the window 54 of sensor 16, but then fall into the outlet 88. Further, by placing the nozzle 20 atop sensor 16, fluid flow pressure may be increased—e.g., as gravity assists in the movement of the fluid. However, examples exist (as described below) wherein the nozzle 20 may be located elsewhere relative to sensor 16.

Returning to FIG. 2, computer 24 is shown electrically coupled to pumping system 14 and sensor 16-19. Computer 24 may be a single computer (or multiple computing devices—e.g., as described above, computer 24 may be shared physically and/or logically with other vehicle systems and/or subsystems). Computer 24 may comprise a processing circuit or processor 196 coupled to memory 198. For example, processor 196 can be any type of device capable of processing electronic instructions, non-limiting examples including a microprocessor, a microcontroller or controller, an application specific integrated circuit (ASIC), etc.—just to name a few. In general, computer 24 may be programmed to execute digitally-stored instructions, which may be stored in memory 198, which enable the computer 24, among other things: to determine the presence of debris on any one of sensors 16-19, selectively control fluid delivery to sensors 16-19 (e.g., selectively controlling which sensor(s) to clean and what type of fluid to deliver), selectively controlling delivery of the second fluid (e.g., a gas) to the respective sensor(s), determining whether application of the second fluid removed the debris, when the computer 24 determines that the debris was not removed, selectively control delivery of the first fluid (e.g., a liquid) to sensors 16-19, and when the computer 24 determines that the debris was not removed using the first fluid (or after a threshold quantity of first fluid applications), then generating and/or reporting a diagnostic trouble code (DTC) so that an authorized service technician may address the DTC.

Memory 198 may include any non-transitory computer usable or readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), as well as any other volatile or non-volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. As discussed above, memory 198 may store one or more computer program products which may be embodied as software, firmware, or the like.

Cleaning sensors 16-19 may begin by computer 24 monitoring the sensors for debris—e.g., and then determining to clean debris from one of the sensors (e.g., sensor 16). For example, computer 24 may receive imaging data from sensor 16 and determine that at least a portion of the image is obscured. Based on this determination—e.g., using techniques known in the art—computer 24 may determine that debris is located within the effective field of view (HFOV_{EFF}) of sensor 16. Consequently, computer 24 may determine to attempt to clean debris from the surface 56 of window 54. Thus, computer 24 may actuate pump 34 of system 14 (e.g., and/or port P4). In one example, computer 24 first actuates pump 34 to deliver the second fluid (e.g., compressed air) to the nozzle 20, and thereafter computer 24 re-determines whether to clean debris from the respective sensor 16. If the debris is not removed, then computer 24 may determine to actuate pump 32 (e.g., and/or port P1) to deliver the first fluid (e.g., liquid cleaning solution) to the surface 56. Again, computer 24 may determine whether the debris is removed. If it is not, computer 24 may actuate again pump 32 and/or port P1 repeating delivery of liquid (e.g., even multiple times). If the debris is not removed still (as determined by computer 24), then computer 24 may generate a diagnostic code. If at any time, the debris is suitably removed from the sensor 16, then computer 24 returns to monitoring sensor 16.

When the computer 24 actuates fluid (e.g., gas or liquid) delivery to the nozzle 20 in the process described above, fluid is received into the inlet 86 via the respective passage (e.g., passage L1)—according to the shape of the inlet 86, this fluid is directed into the circumferential passage 84. In one example, an entry angle of the fluid into passage 84 is at least partially tangential to the circumferential fluid-flow direction 110 within passage 84 thereby promoting circulation. At least some fluid may circulate repeatedly 360° around the passage 84, and during this time, some of the fluid will be displaced through the circumferential outlet 88. Based on the shape and orientation of the outlet 88 and is position relative to sensor 16, the fluid is directed at the window 54 of sensor 16. In at least one example, the width of the outlet 88 is uniform thereby creating a fluid blade having an even pressure distribution. In at least some gaseous-fluid examples, additional air surrounding the outlet 88 is moved with the gas delivered through the outlet 88, according to the entrainment effect described above.

Other examples also exist. For example, the nozzle (20-23) could be coupled to the bottom 50 of the respective sensor—e.g., directing fluid upwardly along the side(s) 52 thereof. In this manner, the respective sensors may or may not have a dead zone.

According to another example, circumferential wall 152 could protrude from upper member 80 and abut against lower member 82 (e.g., inboard of flange 156). Still other examples exist as well.

Thus, there has been described a cleaning system for a vehicle. The system includes a pumping system that delivers one or more fluids to a nozzle positioned relative to a vehicle sensor. In at least one example, the nozzle is coupled to a top of the respective sensor. The nozzle includes a first member and a second member which, when coupled to one another form a circumferential passage and an at least partially circumferential outlet which directs fluid flow evenly along a surface of the sensor—e.g., to clean debris from a window thereof.

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor may be programmed to receive imaging data, control vehicle pumps, control vehicle heaters, etc. Processing the data may include processing the video feed or other data stream captured by the sensors to determine the roadway lane of the host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

The terms upward, upwardly, downward, downwardly, etc. are relative terms meant for purposes of explanation only and should not be construed as limitations.

1. A system, comprising:
a nozzle, comprising:
a first member having a first base and an annular first flange extending therefrom;
a second member, coupled to the first member, having a second base and an annular second flange extending therefrom, the first and second flanges forming a passage;
an inlet; and
an outlet formed by the first and second flanges, wherein the inlet, the passage, and the outlet are in fluid communication with one another.

2. The system of claim 1, further comprising a plurality of sensors and a plurality of nozzles, wherein each of the plurality of sensors is coupled one of the plurality of nozzles.

3. The system of claim 2, wherein at least one of the plurality of sensors is a light detection and ranging (LIDAR) device that provides imaging data to an autonomous driving system in a vehicle.

4. The system of claim 1, further comprising at least one supply passage and a pumping system that includes at least one pump, wherein the pumping system is in fluid communication with the nozzle via the at least one supply passage.

5. The system of claim 4, further comprising a computer having a processor and memory having instructions executable by the processor that include selectively controlling the pumping system to deliver fluid to the nozzle.

6. The system of claim 4, wherein the at least one pump comprises a first fluid pump within a reservoir adapted to deliver a liquid-fluid to the nozzle, wherein the at least one pump further comprises a second fluid pump adapted to deliver a gaseous-fluid to the nozzle.

7. A nozzle, comprising:
a first member comprising an annular first flange extending radially-inwardly from a first base; and
a second member having an annular second flange extending radially-outwardly from a second base, the first and second flanges forming a circumferential passage and an at least partially circumferential outlet.

8. The nozzle of claim 7, wherein the first base is diametrically larger than the second base.

9. The nozzle of claim 7, wherein at least a portion of the first flange is parallel to at least a portion of the second flange.

10. The nozzle of claim 7, wherein a width of the outlet is uniform.

11. The nozzle of claim 7, wherein the first or second member comprises a circumferentially-extending wall protruding from the respective first or second base, wherein the wall is located inboard of the second flange, wherein an edge of the wall abuts the respective second or first base.

12. The nozzle of claim 11, wherein a peripheral region of the first base, the first flange, the wall, and the second flange form the passage.

13. The nozzle of claim 7, further comprising a fluid inlet formed in the first member, the second member, or both.

14. The nozzle of claim 13, wherein the inlet is adapted to direct fluid tangentially into the passage to cause a circumferential fluid flow therein.

15. The nozzle of claim 7, further comprising a fastener that couples the first member to the second member and that couples the first and second members to a sensor.

16. A system, comprising:
the nozzle of claim 7 coupled to a sensor of a vehicle;
a first supply passage coupled to an inlet of the nozzle; and
a first pump adapted to provide a first fluid to the nozzle, via the first supply passage, for application to the sensor.

17. The system of claim 16, further comprising a second supply passage coupled to a second pump adapted to provide a second fluid to the nozzle, wherein the first fluid is different from the second fluid.

18. The system of claim 17, wherein the second supply passage merges with the first supply passage before the first supply passage couples to the inlet.

19. The system of claim 16, further comprising at least one bracket that couples the sensor to the vehicle.

20. The system of claim 16, further comprising a second sensor, a second nozzle, a second supply passage, and the vehicle, wherein the first and second sensors are positioned on respective A-pillars of the vehicle, wherein respective first and second supply passages are located along respective sides of the first and second sensors so that respective dead zones of the first and second sensors are oriented vehicle-inwardly.
